(19) United States
(12) Patent Application Publication
(10) Pub. No.: US 2024/0264278 A1
(43) Pub. Date: Aug. 8, 2024

(54) TRANSMITTER USED IN LIDAR AND LIDAR

(71) Applicant: SHENZHEN METALENX TECHNOLOGY CO.,LTD, Shenzhen (CN)

(72) Inventors: Chenglong HAO, Shenzhen (CN); Fengze TAN, Shenzhen (CN); Jian ZHU, Shenzhen (CN)

(73) Assignee: SHENZHEN METALENX TECHNOLOGY CO.,LTD, Shenzhen (CN)

(21) Appl. No.: 18/641,425

(22) Filed: Apr. 21, 2024

Related U.S. Application Data
(63) Continuation of application No. PCT/CN2022/129832, filed on Nov. 4, 2022.

(30) Foreign Application Priority Data
Nov. 9, 2021 (CN) 202111320256.7

(51) Int. Cl. G01S 7/481; G02B 1/00

(52) U.S. Cl. CPC G01S 7/4814; G01S 7/4817; G02B 1/002; G02B 2207/101

(57) ABSTRACT

The present disclosure provides a transmitter used for lidar and a lidar, including: a laser surface light source configured to emit an initial beam with an initial divergence angle; a first metalens configured to enable the initial beam to pass through the first metalens and configured to modulate the initial beam with the initial divergence angle into a first beam with a first divergence angle; a second metalens configured to enable the first beam to pass through the second metalens and configured to modulate the first beam with the first divergence angle into a second beam with a second divergence angle, wherein the second beam is configured to generate point clouds or multiple lines in a far field; and wherein, the first metalens is arranged between the second metalens and the laser surface light source.

### CROSS-REFERENCE TO RELATED APPLICATIONS

This application is a continuation of International Patent Application of PCT application serial No. PCT/CN2022/129832, filed on Nov. 4, 2022, which claims the benefit of priority from Chinese Application No. 202111320256.7, filed on Nov. 9, 2021. The content of the aforementioned applications, including any intervening amendments thereto, are incorporated herein by reference.

### TECHNICAL FIELD

The present disclosure relates to the field of optical metalens, in particular to a transmitter used in a lidar and a lidar.

### BACKGROUND

Lidar is a scanning sensor that uses non-contact laser ranging technology, and its working principle is similar to general lidar system, that is, by transmitting laser beams to detect a target, and through the collection of reflected beams to obtain data, these data can generate into accurate three-dimensional image after photoelectric processing. With this technology, it is possible to accurately obtain high-precision information about the physical space environment, and the ranging accuracy can reach centimeter level. Therefore, lidar has been widely used in automotive driving, precision modeling and three-dimensional remote sensing.

The lidar mainly includes a transmitter, a receiver, a signal processing unit and a display unit. Further, the transmitter mainly includes a laser source, an optical modulation module, a beam control module, and a scanning control module. Specifically, after the optical modulation and the laser beam control through the optical modulation module and the beam control module, the laser beam emitted by the light source is projected into a space under the control of the scanning control module, causing the laser beam to scan in the space in a specific manner. When the laser beam irradiates the target, the scattering phenomenon occurs, and the scattered photoelectric signal is received by the receiver of the lidar. Then the signal processing unit converts the scattered photoelectric signal into an electric signal, then amplifies and processes the electric signal, so as to display the target signals on the display unit.

The scanning control module of a conventional lidar transmitter mainly uses a mechanical scanning module or a MEMS scanning module. However, non-mechanical scanning lidar transmitters have gained a lot of attention, because they work without a rotating component, thus decreasing hardware costs and reducing wear and tear to a certain extent. Non-mechanical scanning lidar transmitters also show high-level reliability since they can continue to operate even when several laser sources of laser source arrays are damaged.

Metalens is a planar lens fabricated by a semiconductor manufacturing process, which has the advantages of small volume (thin thickness), light weight, simple structure, low cost, and high capacity. Due to these advantages, the metalens can also be used in the transmitter of lidar. However, in the prior art, the metalens is used only for laser beam collimation in the transmitter of the lidar, and the multiple lines generation still requires a plurality of laser source arrays in a predetermined orientation, and the generation of a far-field point cloud still requires diffractive optics, which do not utilize the advantages of the metalens as described above.

Therefore, there is still a need for a non-mechanical scanning transmitter for lidar that can fully utilize the advantages of metalens.

### SUMMARY

A brief overview of the present disclosure is given below to provide a basic understanding of certain aspects of the present disclosure. However, it should be understood that this summary is not an exhaustive overview of the present disclosure, nor is it intended to identify critical or important parts of the present disclosure, nor is it intended to limit the scope of the present disclosure. The purpose of this summary is merely to give certain inventive concepts of the present disclosure in a simplified form as a prelude to a more detailed description to be given later.

The object of the present disclosure is to provide a transmitter used in a lidar based a metalens and a lidar using the transmitter.

A transmitter used in a lidar is provided according to one aspect of the embodiment of the present disclosure. The transmitter including:
a laser surface light source configured to emit an initial beam with an initial divergence angle;
a first metalens configured to enable the initial beam to pass through the first metalens and configured to modulate the initial beam with the initial divergence angle into a first beam with a first divergence angle;
a second metalens configured to enable the first beam to pass through the second metalens and configured to modulate the first beam with the first divergence angle into a second beam with a second divergence angle, where the second beam is configured to generate point clouds or multiple lines in a far field;
where the first metalens is arranged between the second metalens and the laser surface light source.

In one embodiment, the first divergence angle is smaller than the initial divergence angle; and the second divergence angle is smaller than the first divergence angle.

In one embodiment, a ratio between the first divergence angle and the initial divergence angle is less than ⅕.

In one embodiment, the second divergence angle is determined by a maximal working distance of the lidar and a minimal size of a target object detectable at the maximal working distance.

In one embodiment, the laser surface light source comprises a plurality of laser source arrays; and each laser source array comprises a plurality of laser sources.

In one embodiment, the laser sources in each laser source array are arranged in a symmetrical shape.

In one embodiment, each laser source array is structurally identical.

In one embodiment, a first outgoing light is formed after light emitted by one of the laser sources at a first position of the laser surface light source passes through the first metalens and the second metalens; a first angle refers to an included angle between the first outgoing light and a direction perpendicular to the laser area light source;
a second outgoing light is formed after light emitted by one of the laser sources at a second position of the laser surface light source passes through the first metalens and the second metalens; a second angle refers to an included angle between the second outgoing light and the direction perpendicular to the laser area light source; and
compared with the second position, the first position is further away from a central field of view of the laser surface light source; and the first angle is greater than the second angle.

In one embodiment, the plurality of laser source arrays are sequentially illuminated in a predetermined order.

In one embodiment, the plurality of laser source arrays are sequentially illuminated along an S-shaped route.

In one embodiment, the plurality of laser source arrays are sequentially illuminated along a spiral route.

In one embodiment, the plurality of laser source arrays are randomly illuminated.

In one embodiment, the plurality of laser source arrays, a number of illuminated times of a laser source array within a central field of view is greater than a number of illuminated times of a laser source array outside of the central field of view.

In one embodiment, the number of illuminated times of the laser source array within the central field of view is greater than or equal to 2.

In one embodiment, the plurality of laser source arrays, a number of illuminated times of a laser source array within a central field of view is greater than a number of illuminated times of a laser source array outside of the central field of view.

In one embodiment, the number of illuminated times the laser source array within the central field of view is greater than or equal to 2.

In one embodiment, each of the first metalens and the second metalens comprises a substrate and a layer of microstructures arranged on the substrate, and the layer of microstructures comprises unit cells arranged in an array.

In one embodiment, a size and a shape of the unit cells are determined according to a working wavelength range of the lidar.

In one embodiment, the point clouds or the multiple lines in the far field are generatable by modulating a phase of the initial beam.

A lidar is provided according to other aspect of the embodiment of the present disclosure.

According to the technical scheme of this disclosure, a metalens can be used to collimate the laser beam and generate the point cloud or multiple lines in the far field simultaneously, thereby reducing the number of lenses in the transmitter and then decreasing the overall volume, weight and cost of the lidar. Furthermore, according to the technical scheme of this disclosure, a non-mechanical scanning transmitter can be implemented by a laser surface light source composed of a laser source array, thereby increasing the overall service life of the lidar while reducing the complexity of the transmitter.

### BRIEF DESCRIPTION OF THE DRAWINGS

The accompanying drawings are included to provide a further understanding of the present disclosure and are incorporated herein to form a part of this specification. The accompanying drawings illustrate embodiments of the present disclosure and are used, together with the following description, to illustrate the principles of the present disclosure.

FIG. 1 is a schematic diagram of configuration of a transmitter used in a lidar according to an embodiment of the present disclosure.

FIG. 2 is a plan view of a laser surface light source according to embodiments of the present disclosure.

FIGS. 3A to 3D illustrate a plurality of laser source arrays included in a laser surface light source according to embodiments of the present disclosure that are sequentially illuminated.

FIGS. 4A and 4B illustrate a first metalens and a second metalens according to embodiments of the present disclosure in a unit cell in a perspective view.

FIGS. 5A and 5B illustrate microstructures of a first metalens and a second metalens according to embodiments of the present disclosure layers in plan view.

FIGS. 6A to 6C illustrate schematic diagrams of configurations of transmitters used in lidar according to alternative embodiments of the present disclosure.

FIG. 7 illustrates a schematic diagram of a configuration of a transmitter 700 used in a lidar according to embodiments of the present disclosure.

FIG. 8A illustrates the relationship between the size of focal plane spot and field of view when the phase of the point cloud is not considered.

FIG. 8B illustrates a line graph of the modulation transfer function corresponding to the FIG. 8A.

FIG. 9A illustrates a phase diagram of a first metalens according to an example of the present disclosure.

FIG. 9B illustrates a phase diagram of a second metalens according to an example of the present disclosure, and FIG. 9C illustrates a simulation of a point cloud with 256 points projected in the far field according to embodiments of the present disclosure.

FIG. 10 illustrates a line graph of the transmittance and phase of a nanosquare column versus the edge length of the square nanopillar at a working wavelength of 905 nm according to an embodiments of the present disclosure.

### DETAILED DESCRIPTION OF THE EMBODIMENTS

The present disclosure is described more comprehensively with reference to the drawings, and embodiments are shown in the drawings. However, the present disclosure may be implemented in many different ways, and should not be interpreted as limited to the embodiment described herein. Instead, these embodiments are provided such that the disclosure will be exhaustive and complete, and will fully convey the scope of the disclosure to those skilled in the art. The same attached drawing marks throughout indicate the same components. Furthermore, in the drawings, the thickness, ratio and size of the components are enlarged to clearly illustrate.

Terms used in the present disclosure are only used for describing specific embodiments rather than limiting the present disclosure. The terms “one”, “said”, and “the” in a singular form used in the specification and the claims are intended to include a plural form unless other meanings are clearly indicated in the context. It should be understood that the term “and/or” as used intends to include any or all possible combinations of one or more associated and listed items.

If a term is defined in a commonly used dictionary, it shall be construed to have the same meaning as in the context of the technology to which it relates and, unless expressly limited in the specification, shall not have an idealized or overly formalized meaning.

The meaning of “including” or “comprising” specifies a nature, quantity, step, operation, part, component or combination thereof, but does not exclude other natures, quantities, components or combinations thereof.

Embodiments are described herein with reference to cross-sectional views as idealized embodiments. Thereby, it is foreseen that as examples that shape variations relative to the illustrations, as a result of manufacturing techniques and/or tolerances. Accordingly, the embodiments described herein should not be interpreted as being limited to specific shapes of regions as illustrated herein, but rather should include deviations in shape due to, for example, manufacturing. For example, regions shown or described as flat may typically have rough and/or non-linear characteristics. Moreover, the illustrated sharp corners may be chamfered. Therefore, the areas shown in the drawings are schematic in nature and their shapes are not intended to show the precise shape of the areas and are not intended to limit the scope of the claims.

Hereinafter, the exemplary embodiments according to the present disclosure will be described with reference to the accompanying drawings.

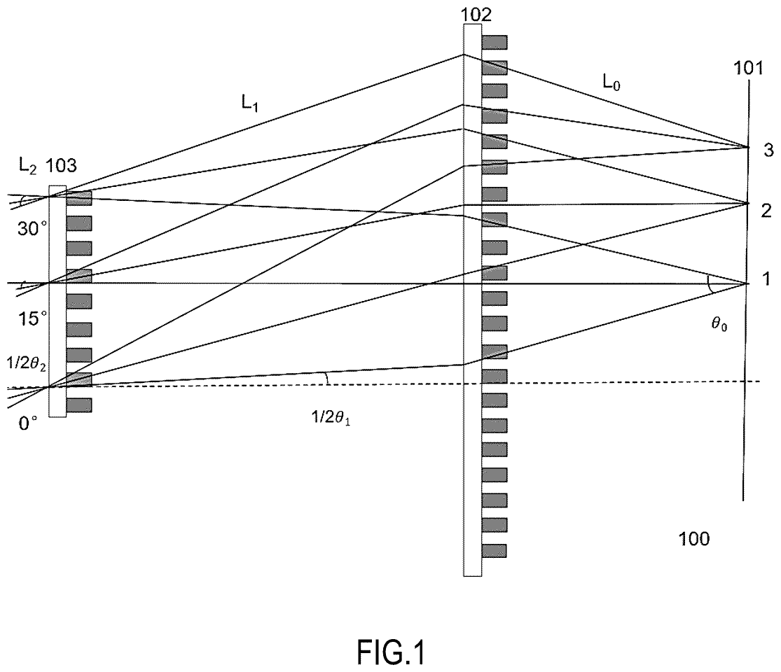

FIG. 1 illustrates a schematic diagram of the configuration of the transmitter 100 used in a lidar according to the embodiment of the present disclosure.

As shown in FIG. 1, a transmitter 100 used in a lidar of the present disclosure, includes: a laser surface light source 101 configured to emit an initial beam L₀ with an initial divergence angle θ₀; a first metalens 102 configured to enable the initial beam L₀ to pass through the first metalens 102 and configured to modulate the initial beam L₀ with the initial divergence angle θ₀ into a first beam L₁ with a first divergence angle θ₁; a second metalens 103 configured to enable the first beam L₁ to pass through the second metalens 103 and configured to modulate the first beam L₁ with the first divergence angle θ₁ into a second beam L₂ with a second divergence angle θ₂, where the second beam L₂ is configured to generate point clouds or multiple lines in a far field; where the first metalens 102 is arranged between the second metalens 103 and the laser surface light source 101, and the first divergence angle L₁ is smaller than the initial divergence angle L₀, and the second divergence angle θ₂ is smaller than the first divergence angle θ₁. As is further described in detail below, the second divergence angle θ₂ is extremely small and close to zero, which means the second beam L₂ is approximate to parallel lights, so the specific location of the second divergence angle θ₂ is not clearly marked in FIG. 1.

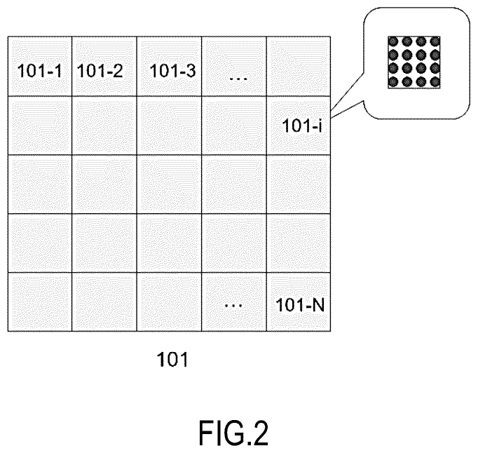

FIG. 2 shows a planar view of the laser surface light source 101 according to the embodiment of the present disclosure.

According to the embodiment of the present disclosure, the laser surface light source 101 includes a plurality of laser source arrays, and each laser source array consists of a plurality of laser sources.

In this embodiment, as shown in FIG. 2, the laser surface light source 101 may have a form of a plurality of laser source arrays. According to the embodiment of the present disclosure, the laser surface light source 101 may include N structure-identical laser source arrays 101-i, 1≤i≤N. Preferably, N is the square number of natural numbers greater than 1, such as 4,9,16,25, etc. For example, the laser surface light source 101 in FIG. 2 includes 5×5 (i.e. N=25) laser source arrays of 101-1 to 101-25. According to the embodiment of the present disclosure, each laser source array consists of a plurality of laser sources.

According to the embodiment of the present disclosure, each laser source array may include M laser sources with identical structure, where M is a natural number greater than 1. For example, as shown in FIG. 2, each laser source array may include, for example, 4×4 (i.e., M=16) laser sources. According to the embodiment of the present disclosure, each laser source array 101-i may also include a more or less number of laser sources. Although the laser source in each laser source array 101-i in FIG. 2 is shown in a square arrangement, but the present disclosure is not limited thereto, and the laser source in each laser source array 101-i may also be arranged in a regular hexagonal or other shape with spatial symmetry.

As shown in FIG. 1, the laser beam emitted by the laser surface light source 101 generates a point cloud or multiple lines in the far field through the compression and collimation of the first metalens 102 and the second metalens 103. Since the laser source at different locations on the laser surface light source 101 corresponds to different outgoing angles at the second metalens 103, and then to different field of view angles at the far field, the laser beam emitted at the non-central field of view of the laser surface light source 101 corresponds to the oblique outgoing parallel light in the far filed and then responds to point cloud or multiple lines. For example, as shown in FIG. 1, relative to the direction perpendicular to the laser surface light source, the laser beam emitted by the laser source at the position 1 from the center of field of view of the laser surface light source 101 has a field of view of 0° after passing through the second metalens 103, the laser beam emitted by the laser source at position 2 off the center of the laser surface source 101 has a field of view of 15° after passing through the second metalens 103, and the laser beam emitted by the laser source at position 3 away from the center of the laser surface light source 101 has a field of view of 30° after passing through the second metalens 103.

Therefore, according to the embodiment of the present disclosure, a plurality of laser source arrays 101-i include in the laser surface light source 101 are successively illuminated. In other words, since the laser source of the non-central field of view of the laser surface light source 101 corresponds to the oblique outgoing parallel light in the far filed and then responds to point cloud or multiple lines, successive illumination of laser source arrays in the laser surface light source 101 can be applied to scan in the far field.

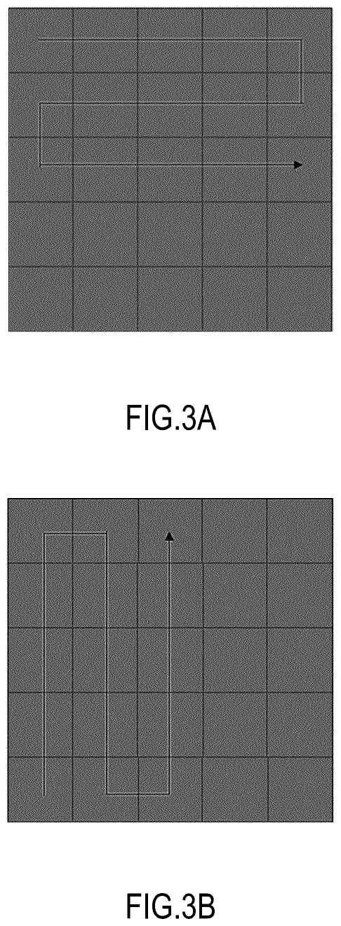

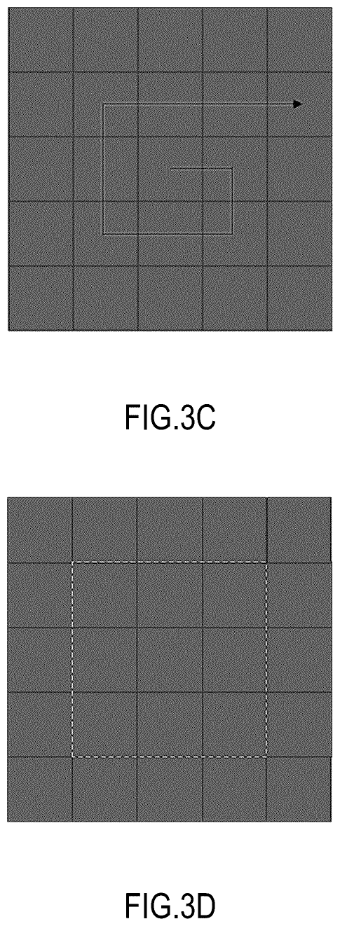

FIGS. 3A to 3D illustrate a schematic diagram of an embodiment of the laser source arrays 101-i illumination, which is included in the laser surface light source 101 provided by the present disclosure.

According to the embodiment of the present disclosure, the plurality of laser source arrays 101-i are sequentially illuminated in a predetermined order. As shown by the arrow in FIG. 3A, the plurality of laser source array 101-i may be sequentially illuminated along an S-shaped route in the horizontal direction. According to the embodiment of the present disclosure, the plurality of laser source array 101-i may be sequentially illuminated along an S-shaped route in the by the arrow shown in FIG. 3B. According to the embodiment of the present disclosure. As shown by the arrow in FIG. 3C, the plurality of laser source arrays 101-i may be sequentially illuminated along a spiral route from the laser source array at the central position of the field of view. After each of the entire plurality of laser source array 101-i is illuminated once, a scanning period is completed, and then the next scanning period begins.

Those skilled in the art should recognize that the illumination way of the laser source array 101-i of the laser surface light source 101, or the scanning method, is not limited to the embodiments shown in FIGS. 3A to 3C, and according to the embodiment of the present disclosure, the laser source array 101-i may also be sequentially illuminated in any other set order.

Further, according to the embodiment of the present disclosure, a plurality of laser source arrays 101-i may also be randomly illuminated. In one embodiment, during a scanning period, the plurality of laser source arrays 101-i may be illuminated in a random order, as long as each of the multiple laser source arrays 101-i is illuminated once. After each laser source arrays 101-i of the entire laser surface light source 101 is illuminated once, a scanning period is completed, and then the next scanning period begins.

According to the implementation of this disclosure, in the plurality of laser source arrays 101-i, a number of illumination times of a laser source array within a central field of view is greater than a number of illumination times of a laser source array outside of the central field of view. As shown in FIG. 3D, the laser source array in the laser source array 101-i, which is included in the laser surface light source 103 and corresponds to the central field of view, is marked by a dashed box. In order to ensure that the lidar has sufficient refresh frequency for the forward central field of view, the central field of view needs to be scanned multiple times in each scanning period. Therefore, according to the embodiment of the present disclosure, in each scanning period, the number of illumination times of the laser source array outside the central field of view (i.e. outside the dashed box) is set to 1, and the number of the illumination times of the laser source array in the central field of view (i.e. within the dashed frame) is set to m, where m is a natural number greater than or equal to 2. According to the embodiment of the present disclosure, in each scanning period, the laser source array 101-i may be illuminated in a predetermined sequence, in which the laser source array outside the central field of view is illuminated only once, while the laser source array inside the central field is illuminated m times. The scanning method of different illumination times (frequencies) of the laser source arrays in different locations ensures that the lidar has sufficient refresh frequency for the front center field of view.

According to the embodiment of the present disclosure, the plurality of laser source arrays 101-i included in the laser surface light source 101 can be randomly illuminated, as long as the a number of illumination times of the laser source array corresponding to the central field of view is greater than a number of illumination times corresponding to the outside of the laser source array. It can reduce the crosstalk of point cloud data in the process of sequentially illuminating the laser source array within a close filed of view.

Next, the first metalens 102 and the second metalens 103 according to the embodiment of the present disclosure will be described in more detail.

Metalens is a specific application of a metasurface. The metalens is a sub-wavelength artificial layers of nanostructures that can modulate the outgoing light according to the unit cells of metalens. The unit cells of the metalens contain full dielectric medium or plasma nanoantennas, which can directly modulate characteristics of light such as the phase, amplitude and polarization.

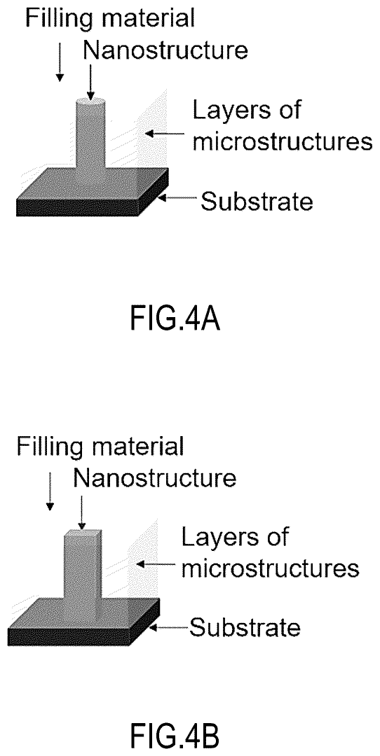

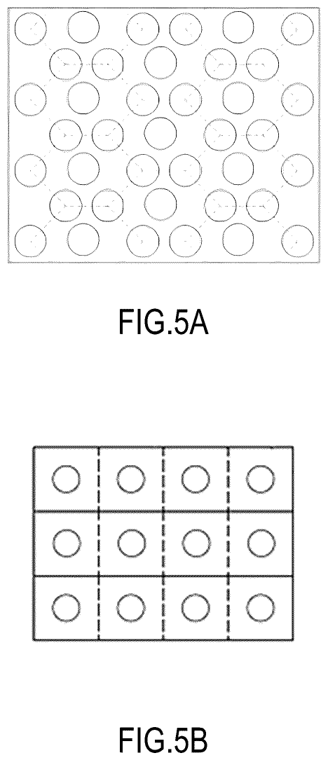

FIGS. 4A and 4B show a perspective view of a unit cell of the first metalens 102 and the second metalens 103 according to the embodiment of the present disclosure. FIGS. 5A and 5B show a planar view of the layers of microstructures of the first metalens 102 and the second metalens 103 according to the embodiment of the present disclosure.

As shown in FIGS. 4A and 4B, according to the embodiment of the present disclosure, each of the first metalens 102 and the second metalens 103 includes a substrate and a layer of microstructures arranged on the substrate, and the layer of microstructures includes unit cells arranged in an array.

As shown in FIG. 5A, according to the embodiment of the present disclosure, the unit cells may be arranged as an array of regular hexagonal shapes. Furthermore, as shown in FIG. 5B, according to the embodiment of the present disclosure, the unit cells may be arranged in a square array. Those skilled in the art should recognize that the arrangement of unit cells included in the layer of microstructures may also include other array forms, all of these variations are covered within the scope of the present disclosure.

According to the embodiment of the present disclosure, the unit cells may have a nanostructure. As shown in FIGS. 4A and 4B, according to the embodiment of the present disclosure, nanostructures are respectively provided at the central and/or vertex positions of each unit cell. According to the embodiment of the present disclosure, the nanostructure is a full dielectric structure. According to the embodiment of the present disclosure, the nanostructure has a high transmittance in the near-infrared optical band. According to the embodiment of the present disclosure, the nanostructure may be made of at least one of the materials: titanium oxide, silicon nitride, molten quartz, alumina, gallium nitride, gallium phosphate, amorphous silicon, crystalline silicon, hydrogendized amorphous silicon and the like.

Nanostructures in the unit cells of the metalens can have the form of nanopillars. Although the section of the nanopillars shown in FIG. 4A is circular and the section of the nanopillars shown in FIG. 4B is square, this disclosure is not limited thereto. The nanostructures may also be other forms of structure, and all of suchlike variations are covered within the scope of the present disclosure.

According to the embodiment of the present disclosure, the size and shape of the unit cells are determined according to the working band of the lidar. That is, the working bands of the first metalens 102 and the second metalens 103 are the working wavelength bands of the lidar, including 850 nm, 905 nm, 940 nm, 1550 nm, etc. According to the embodiment of the present disclosure, the respective nanostructures may be filled with air or other transparent or translucent materials in the working band. According to the embodiment of the present disclosure, the absolute value of the difference between the refractive index of the filled material and the refractive index of the nanostructure should be greater than or equal to 0.5.

As shown in FIG. 1, the first metalens 102 may compress the initial beam L₀ with an initial divergence angle θ₀ emitted by the laser surface light source 101 into a first beam L₁ having a first divergence angle θ₁. According to the embodiment of the present disclosure, the ratio between first divergence angle θ₁ and initial divergence angle θ, is less than ⅕. Furthermore, according to the embodiment of the present disclosure, the phase 41 on the first metalens 102 may correct the aberration of the convergence phase of the second metalens 103.

Furthermore, according to the embodiment of the present disclosure, the laser surface light source 101 is arranged near the focal plane of the first metalens 102. Specifically, according to the embodiment of the present disclosure, the distance between the laser surface light source 101 and the first metalens 102 shall be less than the depth of focus of the first metalens 102. The depth of focus Δf of the first metalens 102 can be determined by the following equation (1).

$$Δ f = \pm 2 {λ}_{c} {F}^{2} \qquad ( 1 )$$

λ_{c} is the central wavelength of the laser beam, and F is the F-number of the first metalens, F is calculated by dividing the focal length of the first metalens 102 by the caliber of the first metalens 102.

Further, as shown in FIG. 1, the second metalens 103 may further compress the first beam L₁ having the first divergence angle θ₁ transmitted through the first metalens 102 into a second beam L₂ having the second divergence angle θ₂. According to the embodiment of the present disclosure, the second beam L₂ is used to generate a point cloud or multiple lines in the far field, so that the second divergence angle θ₂ should satisfy the following equation (2).

$$θ \cdot L \leq d \qquad ( 2 )$$

L is the farthest working distance of the lidar, and d is the smallest size of the target that can be detected at the farthest working distance L. That is, according to the embodiment of the present disclosure, the second divergence angle θ₂ is determined by the farthest working distance of the lidar and the smallest size of the detectable target at the farthest working distance. Generally, the farthest working distance L is much greater than the smallest size d of the target that can be detected at the farthest working distance L, so the second divergence angle θ₂ is extremely small (θ₂ approximates zero and therefore θ₂ is not shown in FIG. 1), so that the second beam L₂ approximates parallel light.

As described above, the second metalens 103 has the function of compressing and collimating the laser beam. In one embodiment, if the phase required for the second metalens 103 to compress the divergence angle of the laser beam is Qc, and the corresponding phase qc can be calculated by inverse deduction method. The inverse deduction method may be calculated by the parallel light with the maximum field of view incident and focusing on the laser surface light source 101.

Further, according to the embodiment of the present disclosure, the second metalens 103 also has a function of generating a point cloud or multiple lines in the far field. Specifically, a laser beam emitted from the laser source arrays at different positions in the laser surface light source 101 is added to a phase φₚ for generating a point cloud or multiple lines in the far field.

In conclusion, considering the above two functions of the second metalens 103, the phase φ₂ of the second metalens 103 can be calculated by the following equation (3).

$${φ}_{2} = mod ( {φ}_{c} + {φ}_{p} , 2 π ) \qquad ( 3 )$$

The mod( ) is the MOD function. φₚ can be given by a phase recovery method through taking the point cloud or multiple lines patterns into consideration and the phase recovery method may be the G-S algorithm. Given that the phase modulation method of lidar is known to those skilled in the art, its details are not described in more detail in this paper.

Thus, according to the embodiment of the present disclosure, a point cloud or multiple lines may be generated at the far field by modulating the phase of the initial beam.

Furthermore, according to the embodiment of the present disclosure, the caliber of the second metalens 103 is less than the caliber of the first metalens 102. This is determined by the function of the first metalens 102 and the second metalens 103. Specifically, the first metalens 102 directly faces the laser surface light source 101 for compressing the initial beam L₀ with a large initial divergence angle θ₀ into the first beam L₁ with the first divergence angle θ₁, and the first metalens 102 has a large caliber considering the planar size of the laser surface light source 101 and the distance between the laser surface light source 101 and the first metalens 102. In contrast, the second metalens 103 is used to further compress the first divergence angle θ₁ into the second divergence angle θ₂ and to generate point clouds or multiple lines in the far field. Therefore, as shown in FIG. 1, after the light beam passes through the first metalens 102, the laser beam emitted by the laser source array at different positions on the laser surface light source 101 needs to converge to the same position, so that the caliber of the second metalens 103 is less than that of the diameter of the first metalens 102.

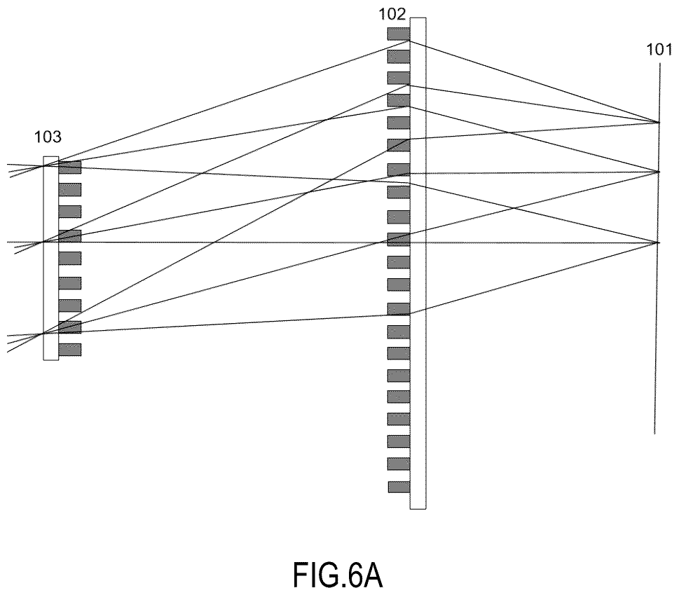

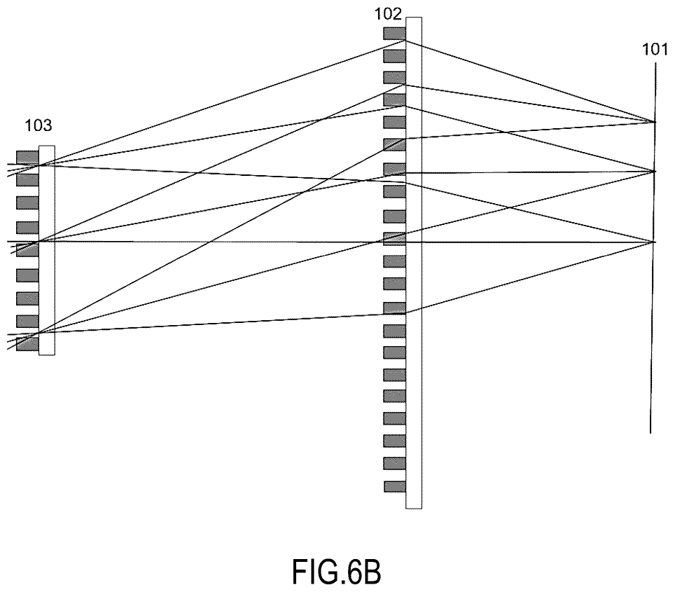

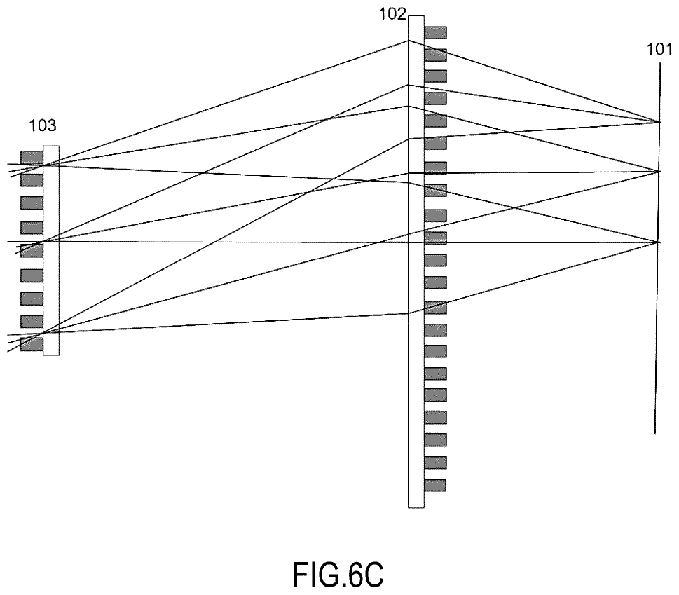

Those skilled in the art should recognize that although the first metalens 102 and the second metalens 103 shown in FIG. 1 have the same orientation, namely, the layers of microstructures of the first metalens 102 and the second metalens 103 are both oriented toward the laser surface light source 101, the present disclosure is not limited thereto. FIGS. 6A to 6C illustrate a schematic diagram of the configuration of the transmitter 100 for the lidar according to the alternate embodiment of the present disclosure. As shown in FIGS. 6A to 6C, the orientation of the layers of microstructures of the first metalens 102 and the second metalens 103 may be arbitrarily set, and all suchlike variations are covered within the scope of the present disclosure.

Further, the present disclosure also provides a lidar, the lidar includes a transmitter as described above.

### EMBODIMENT

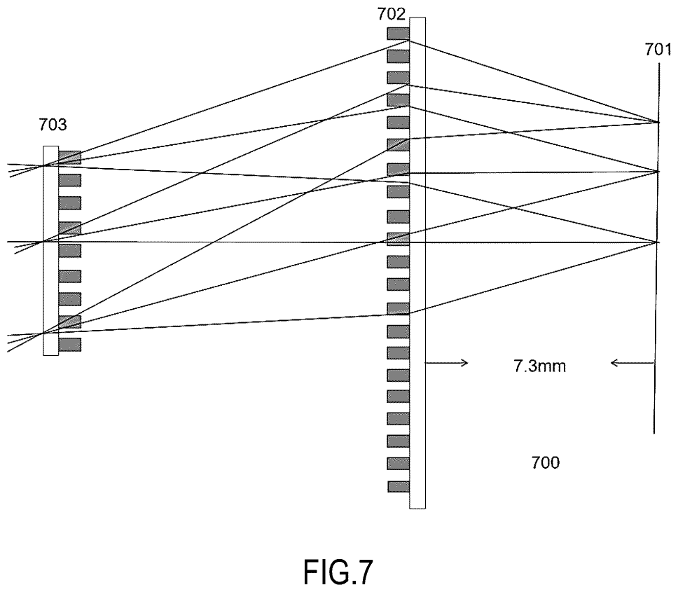

FIG. 7 illustrates a schematic diagram of the configuration of the transmitter 700 for the lidar according to an example of the present disclosure.

The working band of the emitter 700 of this embodiment is at 905 nm, namely a laser beam with a central wavelength of 905 nm. The embodiment of the requirements for beam collimation are as follows: caliber 6 mm, focal length 10 mm, field of view (FOV)=60°, the aberration requirement is characterized by the spot size at the focal plane with parallel incidence which should be less than 100 μm. The projected structure in the far field is a combination of the point cloud or multiple lines.

Accordingly, the diagonal length of the laser surface light source 701 is 11.5 mm, and the distance between the laser surface light source 701 and the first metalens 702 is 7.3 mm. The diameter of the first metalens 702 and the second metalens 703 is 17 mm and 7 mm respectively. Those skilled in the field should recognize that the “caliber” and “diameter” of the lens mentioned herein are two different concepts. Specifically, the “diameter” in this embodiment refers to the entrance pupil diameter of the lens, while the “diameter” refers to the geometric diameter of the lens.

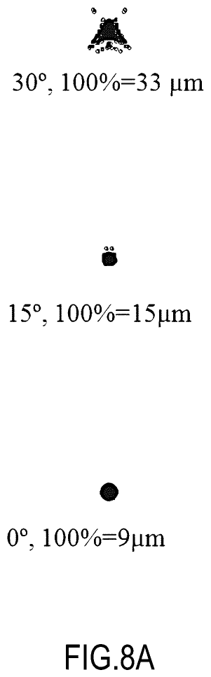

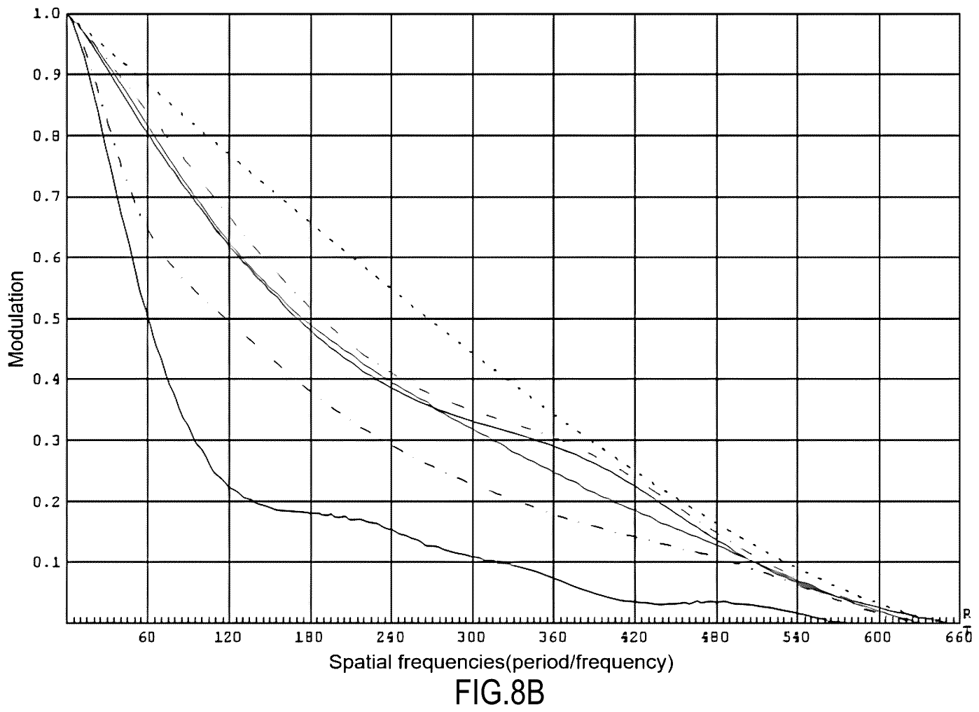

FIG. 8A shows the relationship between the spot size at the focal plane and the field of view angle without considering the point cloud phase. As shown in FIG. 8A, the maximum spot is 33 μm, less than design requirement which may be 100 μm.

FIG. 8B shows a line graph of the modulation transfer function corresponding to FIG. 8A.

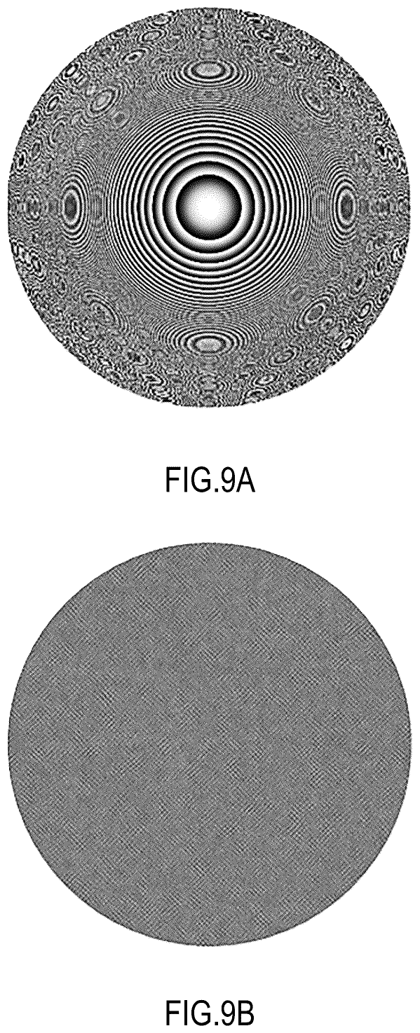

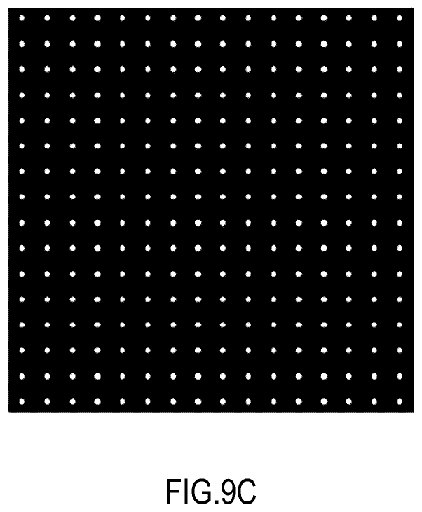

Further, FIG. 9A shows a phase diagram of the first metalens 702 according to the example of the present disclosure, FIG. 9B shows a phase diagram of the second metalens 703 according to the example of the present disclosure, and FIG. 9C shows a simulation diagram of a point cloud with 256 points projected at the far field according to the example of the present disclosure.

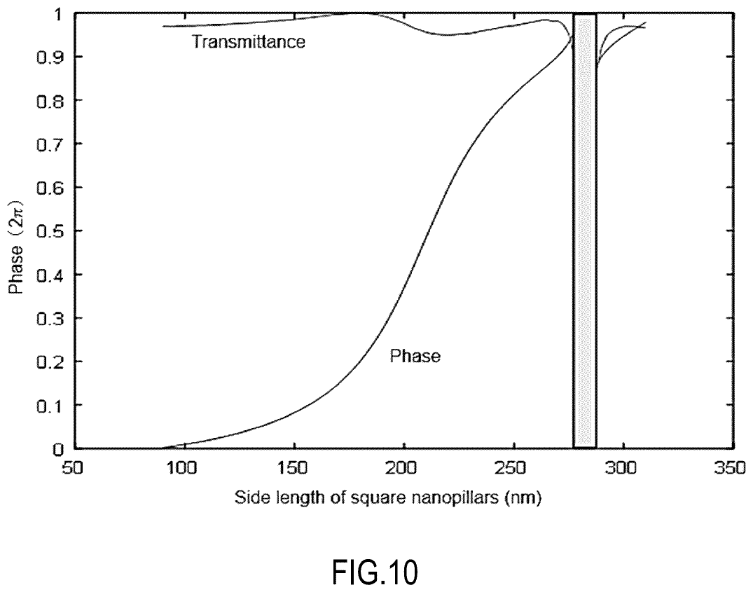

FIG. 10 shows a line graph of the relationship between the transmittance of the square nanopillars, the phase and the side length of the square nanopillar at the working band of 905 nm according to the example of the present disclosure.

According to the phase of the first metalens 702 and the second metalens 703 shown in FIGS. 9A and 9B, considering the data of the nanostructures at the working band of 905 nm as shown in FIG. 10, the corresponding nanostructures may be chosen and arranged according to the phases at different positions, thus obtaining the entire processing map of the first metalens 702 and the second metalens 703. And the unit cells of the first metalens 702 and the second metalens 703 both have square periodicity with a side length of 450 nm. And the substrate material of the first metalens 702 and the second metalens 703 are quartz glass. The material of the nanostructure is amorphous silicon, and the nanostructure is the square nanopillars with side length ranging from 100 nm to 350 nm and column height of 600 nm. The filling material between the square nanopillars is silane, covering the phase from 0 to 2π. And the average transmittance of the square nanopillar is greater than 95.6%.

According to the transmitter used for the lidar and the transmitter, a metalens can be used to collimate the laser beam and generate the point cloud or multiple lines in the far field simultaneously, thereby reducing the number of lenses in the transmitter and then decreasing the overall volume, weight and cost of the lidar. Furthermore, according to the technical scheme of this disclosure, a non-mechanical scanning transmitter can be implemented by a laser surface light source composed of a laser source array, thereby increasing the overall service life of the lidar while reducing the complexity of the transmitter.

Although the present disclosure is described with reference to exemplary embodiments of the present disclosure, those skilled in the art will understand that various modifications and changes may be made without departing from the spirit and scope of the disclosure stated in the claim.

What is claimed is:

1. A transmitter used in a lidar, comprising:
a laser surface light source configured to emit an initial beam with an initial divergence angle;
a first metalens configured to enable the initial beam to pass through the first metalens and configured to modulate the initial beam with the initial divergence angle into a first beam with a first divergence angle;
a second metalens configured to enable the first beam to pass through the second metalens and configured to modulate the first beam with the first divergence angle into a second beam with a second divergence angle, wherein the second beam is configured to generate point clouds or multiple lines in a far field;
wherein, the first metalens is arranged between the second metalens and the laser surface light source.

2. The transmitter according to claim 1, wherein the first divergence angle is smaller than the initial divergence angle; and the second divergence angle is smaller than the first divergence angle.

3. The transmitter according to claim 1, wherein a ratio between the first divergence angle and the initial divergence angle is less than ⅕.

4. The transmitter according to claim 1, wherein the second divergence angle is determined by a maximal working distance of the lidar and a minimal size of a target object detectable at the maximal working distance.

5. The transmitter according to claim 1, wherein the laser surface light source comprises a plurality of laser source arrays; and each laser source array comprises a plurality of laser sources.

6. The transmitter according to claim 5, wherein the laser sources in each laser source array are arranged in a symmetrical shape.

7. The transmitter according to claim 5, wherein each laser source array is structurally identical.

8. The transmitter according to claim 5, wherein a first outgoing light is formed after light emitted by one of the laser sources at a first position of the laser surface light source passes through the first metalens and the second metalens; a first angle refers to an included angle between the first outgoing light and a direction perpendicular to the laser area light source;
a second outgoing light is formed after light emitted by one of the laser sources at a second position of the laser surface light source passes through the first metalens and the second metalens; a second angle refers to an included angle between the second outgoing light and the direction perpendicular to the laser area light source; and
compared with the second position, the first position is further away from a central field of view of the laser surface light source; and the first angle is greater than the second angle.

9. The transmitter according to claim 5, wherein the plurality of laser source arrays are sequentially illuminated in a predetermined order.

10. The transmitter according to claim 9, wherein the plurality of laser source arrays are sequentially illuminated along an S-shaped route.

11. The transmitter according to claim 9, wherein the plurality of laser source arrays are sequentially illuminated along a spiral route.

12. The transmitter according to claim 5, wherein the plurality of laser source arrays are randomly illuminated.

13. The transmitter according to claim 9, wherein in the plurality of laser source arrays, a number of illuminated times of a laser source array within a central field of view is greater than a number of illuminated times of a laser source array outside of the central field of view.

14. The transmitter according to claim 13, wherein the number of the illuminated times of the laser source array within the central field of view is greater than or equal to 2.

15. The transmitter according to claim 12, wherein in the plurality of laser source arrays, a number of illuminated times of a laser source array within a central field of view is greater than a number of illuminated times of a laser source array outside of the central field of view.

16. The transmitter according to claim 15, wherein the number of the illuminated times the laser source array within the central field of view is greater than or equal to 2.

17. The transmitter according to claim 1, wherein each of the first metalens and the second metalens comprises a substrate and a layer of microstructures arranged on the substrate, and
the layer of the microstructures comprises unit cells arranged in an array.

18. The transmitter according to claim 1, wherein a size and a shape of the unit cells are determined according to a working wavelength range of the lidar.

19. The transmitter according to claim 1, wherein the point clouds or the multiple lines in the far field are generatable by modulating a phase of the initial beam.

20. A lidar, comprising the transmitter according to claim 1.
